(19) United States
(12) Patent Application Publication
(10) Pub. No.: US 2006/0136628 A1
(43) Pub. Date: Jun. 22, 2006

(54) Image forming device, directory service providing system having the same and controlling method thereof

(75) Inventor: Jun Choi, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/186,874

(22) Filed: Jul. 22, 2005

(30) Foreign Application Priority Data
Jul. 28, 2004 (KR) 10-2004-0058991

(51) Int. Cl. G06F 13/38

(52) U.S. Cl. 710/72

(57) ABSTRACT

An image forming device, a directory service providing system, and a controlling method thereof. The image forming device includes a portable storage interface in which a portable storage object is loaded, a network interface card for interfacing with the service managing server, and a main controller for registering the portable storage object in the service managing server as an object of the directory service providing system through the interface card when the portable storage object is loaded in the portable storage interface. Accordingly, the portable storage object loaded in the image forming device can be automatically registered as an object of the directory service without a registration process in an information processing terminal of a user.

### CROSS-REFERENCE TO RELATED APPLICATIONS

This application claims the benefit under 35 U.S.C. §119(a) of Korean Patent Application No. 10-2004-0058991 filed in the Korean Intellectual Property Office Jul. 28, 2004, the entire disclosure of which is incorporated herein by reference.

### BACKGROUND OF THE INVENTION

1. Field of the Invention

The present invention relates to an image forming device, a directory service providing system, and a controlling method thereof. More particularly, the present invention relates to an image forming device with a portable storage object that can be loaded or unloaded, a directory service providing system including the image forming device, and a method for controlling the directory service providing system.

2. Description of the Related Art

An image forming device prints an image corresponding to input original image data on a recording medium such as printing paper. Examples of image forming devices include printers, photocopying machines, and facsimiles. Among the image forming devices, printers are one of the peripherals of an information processing terminal, that is, a computer, which provide a user with the contents of what was prepared in the information processing terminal by printing the contents on paper.

A directory service system refers to a system that manages all of the resources registered in a network environment in a central service managing server, and makes the network resources share information and data with each other. Examples of the directory service include an Active Directory developed by the Microsoft company, and a Novell Directory Service (NDS) developed by the Novell company. These directory services are based on the Lightweight Directory Service Protocol (LDAP) and are currently widely used.

Recently, the image forming devices have been further connected with a plurality of information processing terminals through wired or wireless Local Area Network (LAN) to be shared by a plurality of users. Accordingly, the usage efficiency of each image forming device is increased by adopting the directory service.

The image forming device can be further equipped with its own memory. The memory stores various printing data and data required for printing processes such as drivers. However, the memory of the image forming device has a limit in capacity according to factors which are reflected by price and applicability. To overcome the limit, a portable storage object is often provided and now widely used.

According to conventional technology, if a plurality of users use a portable storage object in the image forming device in a conventional directory service, the users can access the portable storage object on a network through their information processing terminals only after the users register the portable storage object to be shared on the network. The users register the portable storage object to be shared on the network by going through additional steps at their information processing terminals connected to the image forming device, that is, at their computers. This method is troublesome because every individual user of a computer is required to register the image forming device to be shared on the network.

Also, those who do not have technical knowledge regarding the directory service cannot perform the process of registering the portable storage object to be shared on the network. Therefore, a problem exists if users do not have the technical knowledge regarding the directory service, such that the data stored in the portable storage object loaded in the image forming device cannot be used.

Accordingly, a need exists for a system and method for allowing users of a directory service to easily access and use data stored in a portable storage object.

### SUMMARY OF THE INVENTION

It is an object of the present invention to substantially solve the above and other problems, and provide an image forming device that can register a portable storage object, which is loaded in the image forming device, in a directory service managing server automatically so that all users of the directory service can have access to and use the data stored in the portable storage object. The present invention further provides a directory service providing system including the image forming device, and a controlling method thereof.

In accordance with an aspect of the present invention, an image forming device is provided with a portable storage object which is registered as an object in a service managing server of a directory service providing system, which comprises a portable storage interface in which the portable storage object is loaded, a network interface card for interfacing with the service managing server, and a main controller for registering the portable storage object in the service managing server as an object of the directory service providing system through the interface card when the portable storage object is loaded in the portable storage interface.

Preferably, the image forming device further comprises a memory for storing authentication request information which is required when the portable storage object is connected to the service managing server and registered as an object, wherein the main controller performs a control operation to read the authentication request information and transmit the authentication request information to the service managing server through the interface card when the portable storage object is loaded.

Also, preferably, the interface card comprises a network interface card memory for storing the authentication request information which is required when the portable storage object is connected to the service managing server and registered as an object, and a network interface card controller. The main controller generates a load confirmation signal and transmits the load confirmation signal to the network interface card controller when the portable storage object is loaded, and the network interface card controller performs a control operation to read the authentication request information based on the load confirmation signal and transmit the authentication request information to the service managing server.

It is preferable that the main controller further performs a control operation to cancel the registration of the portable storage object, which is registered in the service managing server as an object of the directory service providing system, when the portable storage object is separated from the portable storage interface.

It is preferable that the main controller still further performs a control operation to generate an unload confirmation signal and transmit the unload confirmation signal to the interface card when the portable storage object is unloaded, and the interface card transmits the unload confirmation signal to the service managing server and cancels the registration of the portable storage object.

In accordance with another aspect of the present invention, a directory service providing system is provided, which comprises a service managing server for managing registration of objects in the directory service providing system and storing attributes information of the individual objects, an image forming device registered in the service managing server as an object of the directory service providing system, and a portable storage object that can be loaded in or unloaded from the image forming device, wherein the image forming device is registered in the service managing server as an object of the directory service providing system if the portable storage object is loaded.

It is preferable that, if the portable storage object is loaded, the image forming device reads pre-stored attributes information of the portable storage object and transmits the attributes information to the service managing server, and the service managing server registers the portable storage object as an object of the directory service providing system based on the attributes information.

It is preferable that, if the portable storage object is unloaded, the image forming device transmits a registration cancellation request signal for requesting the cancellation of the registration of the portable storage object, which is registered as an object of the directory service providing system, to the service managing server, and the service managing server cancels the registration of the pre-registered portable storage object based on the transmitted registration cancellation request signal.

In accordance with another aspect of the present invention, a method is provided for controlling a directory service providing system provided with a service managing server for managing the registration of objects, which comprises the steps of a) transmitting pre-stored attributes information of a portable storage object from an image forming device to a service managing server if the portable storage object is loaded in the image forming device which is registered as an object of the service managing server, and b) registering the portable storage object as an object of the directory service providing system in the service managing server based on the transmitted attributes information.

According to embodiments of the present invention, the portable storage object loaded on the image forming device can be registered as an object of the directory service, even though the user does not perform a registration process in his/her own computer.

### BRIEF DESCRIPTION OF THE DRAWINGS

The above aspects and features of the present invention will become more apparent by describing certain embodiments of the present invention with reference to the accompanying drawings, in which:

FIG. 1 is a block diagram illustrating a directory service providing system in accordance with an embodiment of the present invention;

FIG. 2 is a block diagram describing a printer of FIG. 1;

FIG. 3 is a block diagram depicting a network interface card of FIG. 2;

FIG. 4 is a flowchart describing a method for controlling a directory service providing system in accordance with an embodiment of the present invention; and

FIG. 5 is a flowchart illustrating a method for controlling the image forming device in accordance with an embodiment of the present invention.

Throughout the drawings, like reference numerals will be understood to refer to like parts, components and structures.

### DETAILED DESCRIPTION OF THE EXEMPLARY EMBODIMENTS

Certain exemplary embodiments of the present invention will now be described in greater detail with reference to the accompanying drawings.

The matters defined in the description, such as detailed construction and element descriptions, are provided to assist in a comprehensive understanding of the invention. Also, functions or constructions well-known to those skilled in the art are omitted for clarity and conciseness.

In the embodiments of the present invention, a printer is taken and described as an example of an image forming device for convenience in the description. However, the scope of the present invention is not limited to a printer, but rather it can be appreciated that the present invention can be applied to any device that is registered in a directory service.

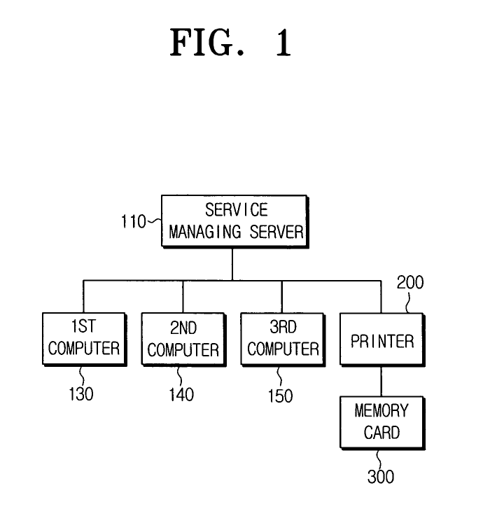

FIG. 1 is a block diagram illustrating a directory service providing system in accordance with an embodiment of the present invention.

As shown in FIG. 1, the directory service providing system comprises a service managing server 110 and one or more objects 130, 140, 150, 200, and 300. Herein, the objects represent physical items on a network. The examples of the objects include a user, group, printer, shared folder, application, database, and the like. Each object is a finite object or actual material that can be confirmed by a user, and each object has attributes information. For example, a user object includes attributes information including a user name, an actual name, and an e-mail address. The required attributes information is different according to the type of object and the kind of directory service. The objects can be specialized by the attributes of each.

The block diagram of FIG. 1 comprises first to third computers 130, 140, and 150, printer 200, and memory card 300, as exemplary objects.

The service managing server 110 and the objects 130, 140, 150, 200, and 300, are connected through wired or wireless Local Area Network (LAN). Herein, the objects 130, 140, and 150, printer 200, and memory card 300, are registered in the service managing server 110, and the service managing server 110 stores attributes information for the individual objects. Thus, the service managing server 110 can manage the objects to share the information and data of each object.

According to an embodiment of the present invention, if the portable storage object, that is, the memory card 300, is loaded in the printer 200, the portable storage object 300 is automatically registered in the service managing server 110 as an object, and the first to third computers 130, 140, and 150, can access the portable storage object 300 without any specific manipulation. For example, in a network wherein the directory service is registered as a virtual domain called ‘mycompany.com’, the printer 200 can have a domain registered as ‘printer.mycompany.com’, and the portable storage object 300 loaded in the printer 200 can have a domain registered as ‘removable_disk.printer.mycompany.com’. Accordingly, the first to third computers 130, 140, and 150, can access the portable storage object 300 at the domain ‘removable_disk.printer.mycompany.com’, and they can each search the stored data and download or upload the data therein.

In FIG. 1, a memory card is presented as an example of the portable storage object 300. In yet other embodiments of the present invention, the portable storage object 300 can be comprised of an external hard disk drive or a Moving Picture Experts Group (MPEG) Audio Layer 3 (MP3) player. Hereafter, an exemplary embodiment of the present invention will be described by using a memory card as an example of the portable storage object 300 for the convenience of the description. However, the scope of the present invention is not limited to a memory card comprising the portable storage object 300.

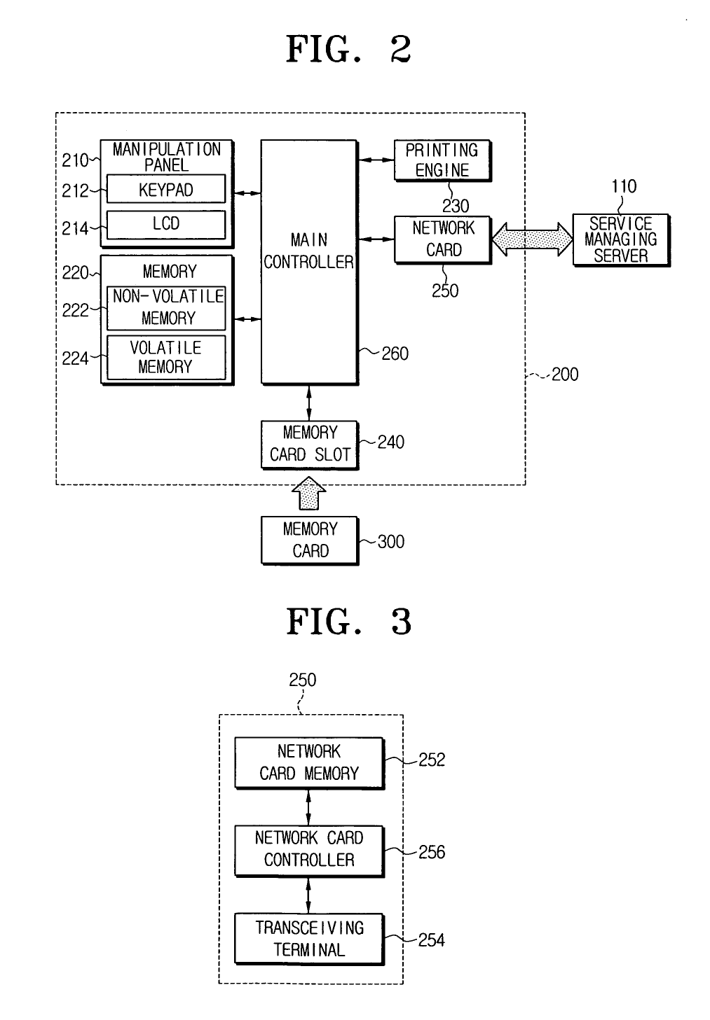

FIG. 2 is a block diagram describing the printer 200 in accordance with an embodiment of the present invention.

The printer 200 comprises a manipulation panel 210, a memory 220, a printing engine 230, a memory card slot 240, a network card 250, and a main controller 260.

The manipulation panel 210 comprises a keypad 212 and a liquid crystal display (LCD) 214. The keypad 212 is provided with a plurality of function keys for setting or selecting various functions supported in the printer 100. If commands are input through the keypad 212, the main controller 260 controls the internal blocks based on the commands. According to an embodiment of the present invention, a user can set up a function for memory card auto-registration through the keypad 212. When the memory card auto-registration function is set up and the memory card 300 is loaded in the printer 200, the memory card 300 is registered as an object of the directory service providing system automatically.

The LCD 214 displays various messages under the control of the main controller 260. According to an embodiment of the present invention, when the memory card auto-registration function is set up and the memory card 300 is loaded in the printer 200, the LCD 214 displays various messages related to the object registration. The registration-related messages include authentication request information, an absence informing message, authentication success message, and authentication failure message.

The memory 220 is comprised of a non-volatile memory 222 and a volatile memory 224. The non-volatile memory 222 stores a control program for realizing the functions of the printer 200, application programs, and a variety of data, while the volatile memory 224 temporarily stores data generated during a control process and a printing process.

According to an embodiment of the present invention, an authentication request message can be stored in the non-volatile memory 222. The authentication request message is information needed to access the directory service providing system and acquire registration as an object. That is, the printer 200 can access the directory service providing system only after it receives an authenticated right to do so. The authenticated right is represented by the authentication request information. The authentication request information comprises an identification (ID) and password of an administrator. The authentication request information can be stored in a number of locations, for example, in a network card memory 252, which is described in greater detail below. However, in an exemplary embodiment provided for illustrative purposes, the authentication request information is stored in the non-volatile memory 222 of the printer 200.

The printing engine 230 prints an image corresponding to the printing data on printing paper under the control of the main controller 260.

The memory card slot 240 is a slot wherein the memory card 300 can be loaded or unloaded. The memory card slot 240 is an interface between the portable storage object 300 and the printer 200. According to embodiments of the present invention, where a medium other than the memory card is applied as the portable storage object 300, other interfaces such as a universal serial port (USB) can be applied.

If the memory card 300 is loaded in or unloaded from the memory card slot 240, an interrupt is generated. The main controller 260 recognizes the loading and unloading of the memory card 300 based on the interrupt. The main controller 260 then reads authentication request information or generates an unload confirmation signal based on the interrupt and transmits the authentication request information or the unload confirmation signal to the network card 250. The unload confirmation signal is a registration cancellation request signal for requesting the cancellation of the registration of the memory card 300 which is pre-registered in the service managing server 110 of the directory service providing system. If the authentication request information is stored in the network card memory 252, the main controller 260 generates a load confirmation signal and transmits the load confirmation signal to the network card 250.

The network card 250 is an abbreviation for a network interface card. The service managing server 110 is connected with the objects 130, 140, 150, 200, and 300, through the network card 250. FIG. 3 is a block diagram describing the internal structure of the network card 250. Referring to FIG. 3, the network card 250 comprises a network card memory 252, a transceiving terminal 254, and a network card controller 256.

The network card memory 252 stores a control program for controlling the general operation of the network card 250 and a network driver which allows the network card 250 to be connected to the network and perform data transmission and reception. Also, the network card memory 252 performs the role of a buffer which temporarily stores the transmission and reception data while the data is transmitted and received on the network. According to embodiments of the present invention, the authentication request information can be stored in the network card memory 252.

The transceiving terminal 254 includes a plurality of connection terminals to be connected with the service managing server 110 and provides an interface with the objects 130, 140, 150, 200, and 300. Diverse data and information is transmitted or received between the printer 200 and the objects 130, 140, 150, 200, and 300, through the transceiving terminal 254.

The network card controller 256 controls the network card 250 generally based on a control program stored in the network card memory 252. Also, the network card controller 256 controls the network card 250 to perform networking according to the network driver stored in the network card memory 252.

If the authentication request information is transmitted upon the control of the main controller 260, the network card controller 256 controls the transmitted authentication request information to be transmitted to the service managing server 110 through the transceiving terminal 254.

If the authentication request information is stored in the network card memory 252, the network card controller 256 of embodiments of the present invention receives a load confirmation signal from the main controller 260. Also, the network card controller 256 performs a control operation to read the authentication request information stored in the network card memory 252 based on the received load confirmation signal and transmit the authentication request information to the service managing server 110 through the transceiving terminal 254.

In addition, if an unload confirmation signal is received from the main controller 260, the network card controller 256 transmits the received signal to the service managing server 10 through the transceiving terminal 254.

The network card controller 256 then receives an authentication success signal or an authentication failure signal from the service managing server 110 and transmits the received signal to the main controller 260.

The main controller 260 is connected with the internal blocks of the printer 200 through a local bus. Regarding the local bus, Peripheral Component Interconnect (PCI) or Industry Standard Architecture (ISA) can be used. The main controller 260 controls the general operation of the printer 200 based on the control program stored in the non-volatile memory 222 of the memory in the printer 200.

The main controller 260 performs a control operation to read the authentication request information stored in the memory 220 based on the interrupt generated when the memory card 300 is loaded in the memory card slot 240 and transmit the authentication request information to the network card 250.

If the authentication request information is stored in the network card memory 252, the main controller 260 performs a control operation to generate a load confirmation signal based on the interrupt generated when the memory card 300 is loaded in the memory card slot 240 and transmit the load confirmation signal to the network card 250.

Also, the main controller 260 generates an unload confirmation signal based on the interrupt generated when the memory card 300 is separated from the memory card slot 240 and transmits the unload confirmation signal to the network card 250.

It is preferable that the main controller 260 performs a control operation to read the authentication request information, and generate the load confirmation signal and the unload confirmation signal only when the memory card auto-registration function is set up through the keypad 212.

Also, the main controller 260 of the embodiments of the present invention performs a control operation to display an authentication success message or an authentication failure message on the LCD 214 based on the authentication success signal or the authentication failure signal from the network card 250.

In addition, when the authentication success signal is received, the main controller 260 performs a control operation to read the attributes information of the memory card 300 stored in the memory 220 and transmit the attributes information to the service managing server 110 through the network card 250.

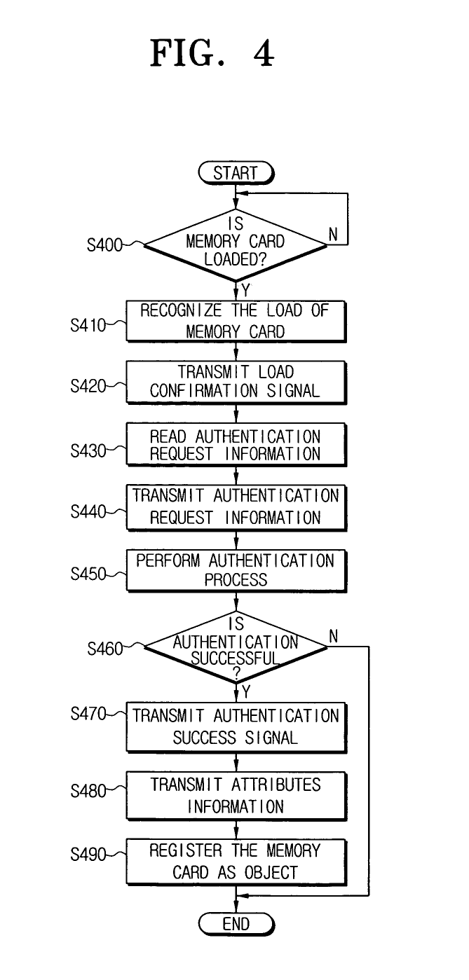

FIG. 4 is a flowchart showing a process of registering the memory card, and describes a method for controlling the directory service providing system in accordance with an embodiment of the present invention. In the embodiment of FIG. 4, it can be assumed that the authentication request information is stored in the network card memory 252.

Referring to FIG. 4, at step S400, a user inserts the memory card 300 into the memory card slot 240 to load the memory card 300 in the printer 200. At step S410, the main controller 260 recognizes that the memory card 300 is loaded. Then, at step S420, the main controller 260 generates the load confirmation signal based on the fact that the memory card 300 is loaded. At step S430, the network card controller 256 of the network card 250 reads the authentication request information stored in the network card memory 252 based on the transmitted load confirmation signal. Subsequently, at step S440, the network card controller 256 transmits the authentication request information to the service managing server 110 through the transceiving terminal 254.

At step S450, the service managing server 110 carries out the authentication process based on the transmitted authentication request information. If the authentication process is performed normally, that is, if the authentication is successful at step S460, the service managing server 110 transmits an authentication success signal to the network card 250 and the network card 250 transmits it to the main controller 260 at step S470. At step S480, the main controller 260 transmits the attributes information of the memory card 300 to the service managing server 110 through the network card 250. At step S490, the service managing server 110 registers the memory card 300 as an object of the directory based on the transmitted attributes information.

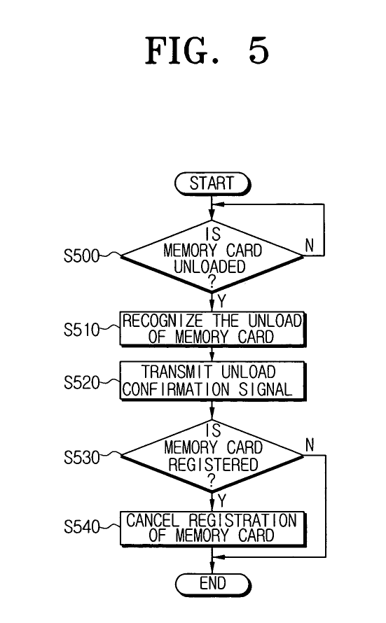

FIG. 5 is a flowchart describing a process of canceling the registration of the memory card 300 as part of a method for controlling the directory service providing system in accordance with an embodiment of the present invention.

Referring to FIG. 5, at step S500, the user separates the memory card 300 loaded on the printer 200. Then, at step S510, the main controller 260 recognizes the separation of the memory card 300. At step S520, the main controller 260 transmits an unload confirmation signal to the service managing server 110 through the network card 250 based on the recognized fact that the memory card 300 is unloaded.

Subsequently, at step S530, the service managing server 110 determines whether the memory card 300 is registered as an object of the service managing server 110 based on the unload confirmation signal. If the memory card 300 is registered, the service managing server 110 cancels the registration of the memory card 300 in the directory at step S540.

According to embodiments of the present invention described above, the portable storage object loaded in the image forming device can be automatically registered in the service managing server 110 as an object of the directory service, even without a registration process in the user information processing terminal, that is, without a physical connection process. In doing so, all the users that are authenticated for the directory service providing system can read or store data by using the portable storage object as their work storage.

The foregoing embodiments and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

What is claimed is:

1. An image forming device with a portable storage object which is registered as an object in a service managing server of a directory service providing system, comprising:
a portable storage interface in which the portable storage object is removably loaded;
a network interface card for interfacing with the service managing server; and
a main controller for registering the portable storage object in the service managing server as an object of the directory service providing system through the interface card when the portable storage object is removably loaded in the portable storage interface.

2. The image forming device as recited in claim 1, further comprising:
a memory for storing authentication request information which is required when the portable storage object is connected to the service managing server and registered as an object, wherein the main controller is programmable to perform a control operation to read the authentication request information and transmit the authentication request information to the service managing server through the interface card when the portable storage object is loaded.

3. The image forming device as recited in claim 1, wherein the interface card comprises:
a network interface card memory for storing the authentication request information which is required when the portable storage object is connected to the service managing server and registered as an object; and
a network interface card controller, wherein the main controller is programmable to generate a load confirmation signal and transmit the load confirmation signal to the network interface card controller when the portable storage object is loaded, and wherein the network interface card controller is programmable to perform a control operation to read the authentication request information based on the load confirmation signal and transmit the authentication request information to the service managing server.

4. The image forming device as recited in claim 1, wherein the main controller is programmable to perform a control operation to cancel the registration of the portable storage object which is registered in the service managing server as an object of the directory service providing system when the portable storage object is separated from the portable storage interface.

5. The image forming device as recited in claim 4, wherein the main controller is programmable to perform a control operation to generate an unload confirmation signal and transmit the unload confirmation signal to the interface card when the portable storage object is unloaded, and wherein the interface card transmits the unload confirmation signal to the service managing server and cancels the registration of the portable storage object.

6. A directory service providing system, comprising:
a service managing server for managing registration of objects in the directory service providing system and storing attributes information of the individual objects;
an image forming device registered in the service managing server as an object of the directory service providing system; and
a portable storage object that can be loaded in or unloaded from the image forming device, wherein the portable storage object is registered in the service managing server as an object of the directory service providing system if the portable storage object is loaded.

7. The directory service providing system as recited in claim 6, wherein the image forming device reads pre-stored attributes information of the portable storage object and transmits the attributes information to the service managing server if the portable storage object is loaded, and wherein the service managing server registers the portable storage object as an object of the directory service providing system based on the attributes information.

8. The directory service providing system as recited in claim 7, wherein the image forming device transmits a registration cancellation request signal for requesting a cancellation of the registration of the portable storage object, which is registered as an object of the directory service providing system, to the service managing server if the portable storage object is unloaded, and wherein the service managing server cancels the registration of the pre-registered portable storage object based on the transmitted registration cancellation request signal.

9. A method for controlling a directory service providing system provided with a service managing server for managing the registration of objects, comprising the steps of:
a) transmitting pre-stored attributes information of a portable storage object from an image forming device to a service managing server if the portable storage object is loaded in the image forming device which is registered as an object of the service managing server; and
b) registering the portable storage object as an object of the directory service providing system in the service managing server based on the transmitted attributes information.

10. The method as recited in claim 9, wherein the step a) comprises the steps of:
a1) transmitting pre-stored authentication request information which is requested when the image forming device is connected to the directory service providing system and requests for registration as an object, from the image forming device to the service managing server if the portable storage object is loaded;
a2) transmitting an authentication success signal from the service managing server to the image forming device if the authentication based on the authentication request information is successful in the service managing server; and
a3) transmitting the attributes information from the image forming device to the service managing server according to the authentication success signal.

11. The method as recited in claim 9, further comprising the steps of:
c) transmitting a registration cancellation request signal from the image forming device to the service managing server if the portable storage object is separated from the image forming device; and
d) canceling the registration of the portable storage object which is registered as an object of the directory service providing system in the service managing server based on the transmitted registration cancellation request signal.

12. A computer program embodied on a computer-readable medium for controlling a directory service providing system provided with a service managing server for managing the registration of objects, comprising:
a) a first source code segment for transmitting pre-stored attributes information of a portable storage object from an image forming device to a service managing server if the portable storage object is loaded in the image forming device which is registered as an object of the service managing server; and
b) a second source code segment for registering the portable storage object as an object of the directory service providing system in the service managing server based on the transmitted attributes information.

13. The computer program embodied on a computer-readable medium as recited in claim 12, wherein the first source code segment comprises:
a1) a source code segment for transmitting pre-stored authentication request information which is requested when the image forming device is connected to the directory service providing system and requests for registration as an object, from the image forming device to the service managing server if the portable storage object is loaded;
a2) a source code segment for transmitting an authentication success signal from the service managing server to the image forming device if the authentication based on the authentication request information is successful in the service managing server; and
a3) a source code segment for transmitting the attributes information from the image forming device to the service managing server according to the authentication success signal.

14. The computer program embodied on a computer-readable medium as recited in claim 12, further comprising:
c) a third source code segment for transmitting a registration cancellation request signal from the image forming device to the service managing server if the portable storage object is separated from the image forming device; and
d) a fourth source code segment for canceling the registration of the portable storage object which is registered as an object of the directory service providing system in the service managing server based on the transmitted registration cancellation request signal.
